(19) United States
(12) Patent Application Publication
(10) Pub. No.: US 2006/0136423 A1
(43) Pub. Date: Jun. 22, 2006

(54) Wireless communication terminal having function for dynamically upgrading platform and method thereof

(76) Inventors: Jae Ho Lee, Daejon (KR); Sun Ja Kim, Daejon (KR); Sang Yun Lee, Daejon (KR); Hwan Gu Lee, Daejon (KR); Woo Sik Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/138,160

(22) Filed: May 25, 2005

(30) Foreign Application Priority Data
Dec. 17, 2004 (KR) 10-2004-0108281

(51) Int. Cl. G06F 7/00; G06F 17/30

(52) U.S. Cl. 707/10

(57) ABSTRACT

A wireless communication terminal having a function for dynamically upgrading a platform and a method thereof is disclosed. The wireless communication terminal includes: a first storing unit for storing an application program interface (API) source; a second storing unit for an API identification correspondently mapped to each of application program interfaces stored in the first storing unit; and a controlling unit for using the application program interface stored in the first storing unit by calling the application program interface based on the API identification and dynamically upgrading mapping information between the first storing unit and the second storing unit according to an API upgrade request signal received from exterior.

### FIELD OF THE INVENTION

The present invention relates to a wireless communication terminal having a function for dynamically upgrading a platform and a method thereof; and, more particularly, to a wireless communication terminal having a dynamic platform upgrade function for adding, updating and deleting an application program interface (API) in a platform of the wireless communication terminal by separately managing an API implementing unit storing an application program interface (API) source and an API defining unit storing API identifications mapped to corresponding application program interfaces stored in the API implementing unit, and subordinating an API user such as an application program and an application program manager to the API defining unit in order to use the upgraded API or use the newly installed API without recompiling existing application programs and a method thereof.

### DESCRIPTION OF THE PRIOR ART

A wireless communication terminal includes a mobile communication terminal, a personal communication service (PCS) terminal, a personal digital assistant (PDA), a smart phone, a wireless local area network (LAN) phone and an international mobile telecommunication (IMT)-2000 phone capable of transmitting/receiving voice and data through wireless communication

A platform provides software environment for executing application program in various hardware such as computer and wireless communication devices. A wireless Internet platform is an environment for operating downloaded application programs in a wireless communication terminal.

It is inconvenient to use a conventional wireless communication terminal that the conventional wireless communication terminal must upgrade entire wireless Internet platform for additionally installing an application program interface (API) in order to improve a performance of existing API in a platform or to solve internal problems of a program. Also, the entire wireless internal platform must be downloaded in the conventional wireless communication terminal for deleting or upgrading the installed API.

Furthermore, the conventional wireless communication terminal must modify the application program and recompile the modified application program after upgrading the entire wireless Internet platform.

### SUMMARY OF THE INVENTION

It is, therefore, an object of the present invention to provide a wireless communication terminal having a dynamic platform upgrade function for adding, updating and deleting an application program interface (API) in a platform of the wireless communication terminal by separately managing an API implementing unit storing an application program interface (API) source and an API defining unit storing API identifications mapped to corresponding application program interfaces stored in the API implementing unit, and subordinating an API user such as an application program and an application program manager to the API defining unit in order to use the upgraded API or use the newly installed API without recompiling existing application interface program in the API, and a method thereof.

It is another object of the present invention to provide a wireless communication terminal having a function for dynamically upgrading a platform, the wireless communication terminal including: a first storing unit for storing an application program interface (API) source; a second storing unit for an API identification correspondently mapped to each of application program interfaces stored in the first storing unit; and a controlling unit for using the application program interface stored in the first storing unit by calling the application program interface based on the API identification and dynamically upgrading mapping information between the first storing unit and the second storing unit according to an API upgrade request signal received from exterior.

In accordance with another aspect of the present invention, there is provided a method for dynamically upgrading a platform in a wireless communication terminal, the method including the steps of: a) storing application program interface (API) source in an API implementing unit and storing an API identification correspondently mapped to each of application program interfaces stored in an API defining unit; b) downloading new application program interface by receiving an API adding request from exterior, storing the downloaded application program interface in the API implementing unit and updating mapping information between the API implementing unit and the API defining unit; c) downloading an application program interface by receiving an API updating request from exterior and updating corresponding application program interface in the API implementing unit; and d) deleting an predetermined program interface by receiving an API deleting request from exterior and updating the mapping information between the API implementing unit and the API defining unit.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating an application program managing module of a wireless communication terminal having a dynamic platform upgrade function in accordance with a preferred embodiment of the present invention;

FIG. 2 is a flowchart of steps for adding an application program interface in a method for dynamically upgrading a platform in accordance with a preferred embodiment of the present invention;

FIG. 3 is a flowchart of steps for updating application program interface (API) in a method for dynamic upgrading a platform in a wireless communication terminal in accordance with a preferred embodiment of the present invention;

FIG. 4 is a diagram for explaining steps for updating a library in a method for dynamically upgrading a platform in a wireless communication terminal in accordance with a preferred embodiment of the present invention; and

FIG. 5 is a flowchart showing steps for deleting an application program interface in a method for dynamically upgrading a platform in a wireless communication terminal in accordance with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

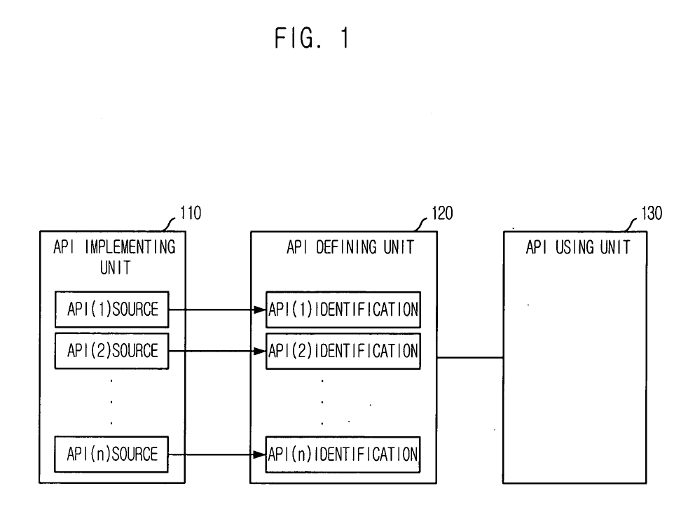

FIG. 1 is a diagram illustrating an application program managing module of a wireless communication terminal having a dynamic platform upgrade function in accordance with a preferred embodiment of the present invention.

As shown in FIG. 1, the wireless communication terminal includes an application program interface (API) managing module for a dynamic platform upgrade function dynamically adding, deleting and updating an application program interface (API) during operating the platform. The API managing module includes an API implementing unit 110, an API defining unit 120 and an API using unit 130.

The API implementing unit 110 occupies a predetermined area of an embedded file system and stores an application program interface (API) source for each interface unit.

The API defining unit 120 stores API identifications correspondently mapped to the application program interfaces stored in the API implementing unit 110.

The API using unit 130 uses the application program interfaces stored in the API implementing unit by calling the application program interface by using the API identifications defined in the API defining unit 120.

In the present invention, the wireless communication terminal separately includes a module for downloading new API to the wireless communication terminal and a function adding, deleting and updating the downloaded API for providing variety of a method for adding new library in the platform of the wireless communication terminal. The downloading new API implementing unit 110 is requested by an application program manager. Also, the downloading new API implementing unit 110 is requested by push of a management server, a user and an application program. The wireless communication terminal uses a wireless link or a serial line for downloading the new API implementing unit 110.

The wireless Internet platform does not participate for downloading the new API implementing unit 110 in the wireless communication terminal and expects that information about the downloaded API is stored in a predetermined area of the EFS as a predetermined file. The application program manager notices addition, deletion and update of new API to the platform by updating the information about the downloaded API to the predetermined file in the platform.

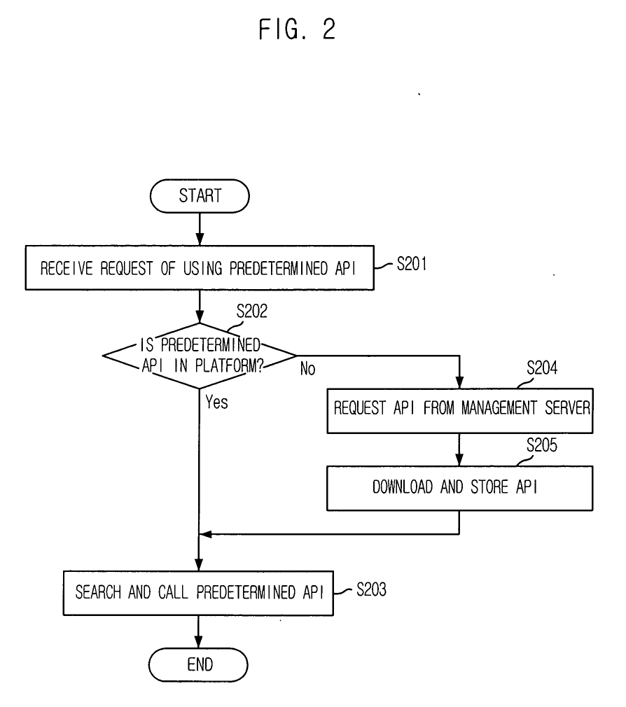

Hereinafter, steps for adding new API in a platform of a wireless communication in accordance with a preferred embodiment of the present invention are explained by referring to FIG. 2.

FIG. 2 is a flowchart of steps for adding an application program interface in a method for dynamically upgrading a platform in accordance with a preferred embodiment of the present invention.

As shown in FIG. 2, the wireless communication terminal receives a request for using a predetermined API at step S201. In the step S201, the wireless communication terminal receives the request by an application program when the application program installed in the wireless Internet platform calls a function and a method relating loading of a dynamic interface explicitly requesting the predetermined API. The application program manager of the wireless Internet platform may request to use the predetermined API without the request of the application program. The request is transmitted to the application program manager of the wireless Internet platform.

And then, the application program manager determines whether an API implementing unit of the request API is in the wireless Internet platform at step S202. The application program manager is an API executing unit. The dynamically downloaded and installed API may have an API identification in a unit of an interface. Based on the API identification of the downloaded API, the application program manager classifies the API. The API identification is expressed as a string name such as “KTF_WIPI_{—}3DAPI2.1.1”, “SKT_WIPI_EXT_SMSInterface1.0”, or “FORUM_WIPI_SOUNDAPI5.1”. Also, the API identification is assigned by a service provider or a manufacturer standard group.

If the requested API implementing unit is not in the wireless Internet platform at step S202, the application program manager requests corresponding API implementing unit to management server through a wireless communication network at step S204. For searching the requested API, the application program manager transmits the API identification of the requested API to the wireless communication network. And then, the management server finds the requested API implementing unit by using the transmitted API identification and transmits the requested API implementing unit to the application manager in the wireless communication terminal. The application program manager of the wireless communication terminal receives the API implementing unit from the wireless network and stores the received API implementing unit in a predetermined area of the embedded file system at step S205.

If there is the requested API implementing unit in the wireless Internet platform of the wireless communication terminal at step S202, the wireless communication terminal calls corresponding API implementing unit from the wireless Internet platform by using the API identification at step S203.

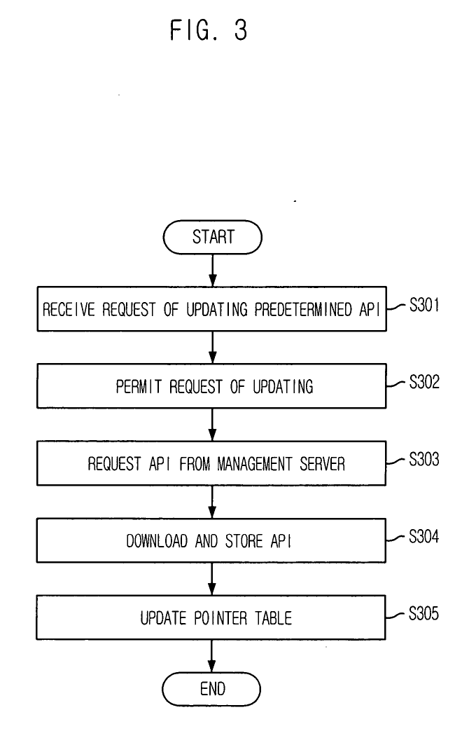

Hereinafter, steps for updating application program interface (API) installed in a platform of the wireless communication terminal by referring to FIG. 3 are explained.

FIG. 3 is a flowchart of steps for updating application program interface (API) in a method for dynamic upgrading a platform in a wireless communication terminal in accordance with a preferred embodiment of the present invention.

As shown in FIG. 3, the wireless communication terminal receives an API update request including an API identification of an API to be updated at step S301. The API updating request may be received from a wireless network based on a push method. A user may directly request to the wireless network to update the API installed in the wireless communication terminal.

After the API updating request is transmitted to the wireless Internet platform of the wireless communication terminal, the application program manager automatically permits to update the corresponding application program interface by searching the corresponding application program based on the API identification according to a predetermined updating rule or the application program manager grants a permission of updating from a user at step S302.

If the API updating request is permitted by the application manager, the wireless network transmits the corresponding application program interface to the application manager at step S303. The application program manager receives the corresponding application program interface and stores the received application program in the embedded file system at step S304. After receiving the application program, the target application program interface of updating may be deleted or not.

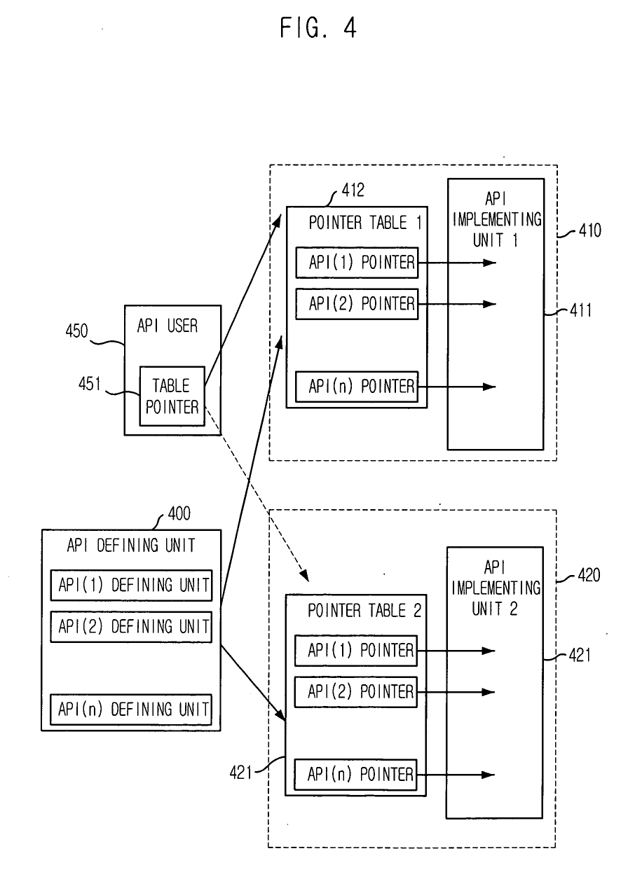

After completing the API update, related information is modified for application programs using the target API to refer the updated API at step S305. The related information is a library and the library is a pointer table of the API implementing unit. Steps for updating the library are explained by referring to FIG. 4 hereinafter.

FIG. 4 is a diagram for explaining steps for updating a library in a method for dynamically upgrading a platform in a wireless communication terminal in accordance with a preferred embodiment of the present invention.

As shown in FIG. 4, an API user 450 can access an API implementing unit 410 or 420 by using a pointer table 451 when the API implementing units 410 and 420 for an API defining unit 400 are included in a platform. In case that the API user 450 uses the API implementing unit 1 410, a location of a pointer table 1 412 pointing the API implementing unit 1 410 is stored in a pointer table 451 of the API user. Therefore, the API user 450 calls an implementing function by using the pointer table 451 for using the API implementing unit 1 410. In case of requesting use of the API implementing unit 2 420 during using the API implementing 1 410, the pointer table 451 is updated to point a pointer table 2 421 of an API implementing unit 421. After updating, all API implementing units of the API user 450 are called by the pointer table 451. Therefore, the API implementing unit 2 421 is used after updating.

As mentioned above, the updated application program interface is used since when application program using the API is re-executed for calling an application program interface. Therefore, an updating result is reflected when the application program is re-executed in case that the API is updated during the application program is executing. In case that the application program interface is built in the platform, the updating result is reflected when the platform is re-performed.

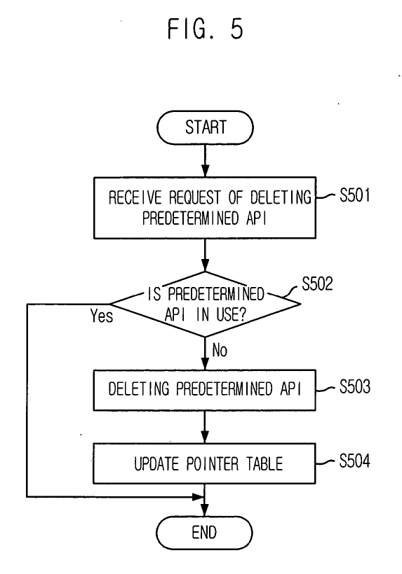

Hereinafter, steps for deleting an application program interface are explained by referring to FIG. 5.

FIG. 5 is a flowchart showing steps for deleting an application program interface in a method for dynamically upgrading a platform in a wireless communication terminal in accordance with a preferred embodiment of the present invention.

As shown in FIG. 5, an application program manager receives a request for deleing a predetermined API at step S501. A user of the wireless communication terminal or another application program may request to delete the predetermined API installed in the wireless communication terminal.

The application program manager determines whether the requested API is used by another program at step S502.

If the requested API is used by another program at step S502, the application program manager outputs a message noticing deny of deletion request to the user and terminates the operation for deleting. If the requested API is not used by another program at step s502, the application program manager deletes the requested application program interface at step S503. And then, a pointer table of the API implementing unit is updated for maintaining a pointer table mechanism at step 504.

As mentioned above, the wireless communication terminal of the present invention includes a open platform structure for using the updated API and newly installed API without recompiling the existing application program by separating the API implementing unit storing an API source and the API defining unit storing the API identifications mapped the APIs in the API implementing unit for independently modifying the API implementing unit and the API defining unit and by subordinating the API user such as the application program and the application program manager only to the API defining unit.

The above mentioned method can be embodied as computer-executable codes on a computer-readable recording medium. The computer-readable recording medium is any data storage device that can store data which can be thereafter read by a computer system. Examples of the computer-readable recording medium includes read-only memory (ROM), random-access memory (RAM), CD-ROMs, magnetic tapes, floppy disks, optical data storage devices and carrier waves (such as data transmission through the Internet).

As mentioned above, according to the present invention, the upgraded API and the newly installed API can be used without recompiling existing applications by separating the API implementing unit storing the API source and the API defining unit storing the API identifications mapped to the APIs stored in the API implementing unit for independently adding, updating and deleting the API implementing unit and the API defining unit, and by subordinating the API user such as the application program and the application program manager only to the API defining unit.

While the present invention has been described with respect to the particular embodiments, it will be apparent to those skilled in the art that various changes and modifications may be made without departing from the scope of the invention as defined in the following claims.

What is claimed is:

1. A wireless communication terminal having a function for dynamically upgrading a platform, the wireless communication terminal comprising:
a first storing means for storing an application program interface (API) source;
a second storing means for an API identification correspondently mapped to each of application program interfaces stored in the first storing means; and
a controlling means for using the application program interface stored in the first storing means by calling the application program interface based on the API identification and dynamically upgrading mapping information between the first storing means and the second storing means according to an API upgrade request signal received from exterior.

2. The wireless communication terminal as recited in claim 1, wherein the controlling means downloads new application program interface according to an API adding request signal from exterior, stores the downloaded new application program in the first storing means, and updates the mapping information between the first storing means and the second storing means.

3. The wireless communication terminal as recited in claim 2, wherein the API adding request signal is generated by an application program installed in a platform of the wireless communication terminal when the application program loads a function and calls a method relating loading of a dynamic interface explicitly requiring a predetermined application program interface.

4. The wireless communication terminal as recited in claim 2, wherein the API adding request signal is generated by a push method of a wireless service provider.

5. The wireless communication terminal as recited in claim 2, wherein the controlling means receives a request of using an application program interface from exterior; determines whether the requested application program interface is installed in the platform by referring to the second storing means, reads and provides the corresponding application program interface from the first storing means if the requested application program interface is already installed; and downloads the request application program interface from a wireless network if the requested application program interface is not installed, stores the downloaded application program interface in the first storing means and updates the mapping information between the first storing means and the second storing means.

6. A method for dynamically upgrading a platform in a wireless communication terminal, the method comprising the steps of:
a) storing application program interface (API) source in an API implementing unit and storing an API identification correspondently mapped to each of application program interfaces stored in an API defining unit;
b) downloading new application program interface by receiving an API adding request from exterior, storing the downloaded application program interface in the API implementing unit and updating mapping information between the API implementing unit and the API defining unit;
c) downloading an application program interface by receiving an API updating request from exterior and updating corresponding application program interface in the API implementing unit; and
d) deleting an predetermined application program interface by receiving an API deleting request from exterior and updating the mapping information between the API implementing unit and the API defining unit.

7. The method as recited in claim 6, wherein the step b) includes the steps of:
b-1) receiving a request of using a predetermined application program interface and determining whether the predetermined program interface is installed in the platform by referring to the API defining unit;
b-2) reading and providing the predetermined application program interface from the API implementing unit if the predetermined application program interface is installed in the platform; and
b-3) downloading the predetermined application program interface from exterior if the predetermined program interface is not installed in the platform, storing the downloaded application program interface in the API implementing unit and updating the mapping information between the API implementing unit and the API defining unit.

8. The method as recited in claim 6, wherein the step c) includes the steps of:
c-1) receiving a request for deleting a predetermined application program interface and determining whether the predetermined application program interface is currently used by another application program;
c-2) outputting a message noticing deny of the request if the predetermined application program interface is currently used by another application program; and
c-3) deleting the predetermined application program interface in the API implementing unit if the predetermined application program interface is not currently used by another application program and updating the mapping information between the API implementing unit and the API defining unit.
